(19) United States
(12) Patent Application Publication
(10) Pub. No.: US 2013/0094019 A1
(43) Pub. Date: Apr. 18, 2013

(54) SAMPLE CARRIER WITH LIGHT REFRACTING STRUCTURES

(71) Applicants: Jacobus Hermanus Maria Neijzen, Eindhoven (NL); Johannes Joseph Hubertina Barbara Schleipen, Eindhoven (NL)

(72) Inventors: Jacobus Hermanus Maria Neijzen, Eindhoven (NL); Johannes Joseph Hubertina Barbara Schleipen, Eindhoven (NL)

(73) Assignee: KONINKLIJKE PHILIPS ELECTRONICS N.V., EINDHOVEN (NL)

(21) Appl. No.: 13/701,185

(22) PCT Filed: May 30, 2011
(86) PCT No.: PCT/IB2011/052371

§ 371 Date: Nov. 30, 2012

(30) Foreign Application Priority Data
Jun. 2, 2010 (EP) 10164755.0

(51) Int. Cl. G01N 21/03

(52) U.S. Cl. CPC G01N 21/03
USPC 356/246

(57) ABSTRACT

The invention relates to a carrier (211) and an apparatus for optical manipulations of a sample in a sample chamber (2), wherein the carrier (211) comprises a contact surface (12) with a plurality of holes (52), particularly grooves (52). In a preferred embodiment, the holes (52) have two oppositely slanted opposing facets (53, 54) that include an angle (2a) of less than about (¾/¾)·140°, with ¾ and n2 being the refractive indices of the carrier and the sample, respectively. Moreover, a light source may be arranged such that it generates an input light beam (LI) which traverses at least two holes (52) before leaving the carrier (211) as an output light beam (L2). Due to the steepness of the facets (53, 54) and/or the multiple passages of the input light beam (LI) through holes (52) it is possible to interact with a sample in the holes in an efficient way and to minimize losses of light.

### FIELD OF THE INVENTION

The invention relates to a carrier and to an apparatus for optical manipulations of a sample in a sample chamber, wherein the carrier comprises an optical structure with holes in a contact surface.

### BACKGROUND OF THE INVENTION

From the WO 2009/125339 A2 a biosensor device is known which comprises a transparent carrier having a contact surface with a plurality of grooves of triangular cross section. The angle included by the side faces of the grooves has a value of about 130° to 150°, a value which is chosen such that an input light beam impinging from within the carrier onto a side face of a groove is refracted into a direction parallel to the contact surface. After traversing the groove, the beam is refracted a second time when reentering the carrier, and it is thus directed away from the contact surface. The described optical structure allows a localized manipulation of a sample within the grooves.

### SUMMARY OF THE INVENTION

Based on this situation it was an object of the present invention to provide robust means for accurate optical manipulations of a sample.

This object is achieved by a carrier according to claim 1 and an apparatus according to claim 2. Preferred embodiments are disclosed in the dependent claims.

The carrier according to a first aspect of the present invention is intended for optical manipulations of a sample in an adjacent sample chamber, i.e. in the space exterior to the carrier. In this context, the term “manipulation” shall comprise any kind of interaction of light with a sample. The manipulation may preferably comprise the qualitative or quantitative detection of target components comprising label particles, wherein the target components may for example be biological substances like biomolecules, complexes, cell fractions or cells. The carrier will usually be made at least partially from a transparent material, for example glass or polystyrene, to allow the propagation of light of a given (particularly visible, UV, and/or IR) spectrum. The sample shall have a refractive index n₂ that is considered to be given in advance, while the refractive index of the (transparent parts of the) carrier is denoted as n₁.

Furthermore, the carrier shall comprise on one of its surfaces an optical structure with a plurality of holes, wherein each hole comprises two oppositely slanted opposing facets that include an angle of less than about 140° times the ratio between the refractive indices of the sample and the carrier, i.e. less than about (n₂/n₁)·140°. The surface comprising the holes will in the following be called “contact surface”, wherein the geometry of this contact surface will usually be approximated as being planar when angles are measured with respect to it and/or reference is made to a “normal” (thus neglecting the local structure due to the holes). It should be noted that the mentioned opposing facets of the holes need not necessarily meet each other; it suffices that they lie in two associated geometrical planes that intersect at the mentioned angle. Moreover, the plurality of holes will enclose intermediate “elevations”. Accordingly, one could equally well characterize the optical structure on the carrier by crests, ridges or the like instead of holes.

In the described carrier, the opposing facets of the holes are unusually steep. In a symmetric design with a typical ratio n₂/n₁ of about 0.88, each facet would for example be tilted at an angle of more than 30° with respect to the contact surface. Light propagating through the carrier in a practically relevant geometry, oriented for example at an angle of about 70° with respect to the normal of the contact surface, will therefore impinge onto a facet under a comparatively shallow angle. This turns out to have a positive effect on the efficiency and robustness of manipulations with said light, which will become more apparent when the invention is described in more detail below.

According to a second aspect, the invention relates to an apparatus for optical manipulations of a sample in a sample chamber, said apparatus comprising the following components:

a) A carrier having a contact surface with a plurality of holes. As above, the carrier will usually be made at least partially from a transparent material.

b) A light source for emitting an input light beam through the carrier towards the contact surface of the carrier such that at least a part of said input light beam traverses at least two holes before leaving the carrier as an output light beam, which will typically be directed away from the contact surface. The light source may for example be a laser or a light emitting diode (LED), optionally provided with some optics for shaping and directing the input light beam.

In the above apparatus, the carrier with at least two holes in its contact surface and the light source have a particular arrangement with respect to each other. This arrangement is such that the input light beam emitted by the light source is redirected at the contact surface by at least four refractions (two at each encountered groove) into an output light beam leaving the carrier. It turns out that such a redirection by multiple refractions has advantages compared to a redirection by one hole only. In particular, the overall light losses occurring at the several encountered holes can be made smaller than the light loss that occurs during a refraction at a single hole (with similar angles of input an output light beam).

Moreover, the passage of the input light beam through several holes increases the volume in which an interaction with a sample can take place, thus increasing the sensitivity of the apparatus in sensing applications. In addition, if the light beam interacts with particles (labels, beads) that are particularly concentrated on the fluid-cartridge interfaces of the holes, the sensitivity increases as a result of the passage of the light through a number of these interfaces.

It should be noted that the exact path of the input light beam depends inter alia on the refractive index n₂ of the medium (sample) in the holes of the carrier. For the purpose of this invention, this refractive index may be considered as being given in advance. The material and/or geometry of the carrier/light source are then selected such that the required behavior (passage of input light beam through two holes) results. A typical value of the refractive index of the medium in the holes ranges between about 1.2 and about 1.5, preferably between about 1.33 and 1.35.

Typical values of the refractive index n₁ of the carrier range between about 1.4 and 1.8, preferably between about 1.5 and 1.6.

The carrier that is used in the described apparatus may particularly be a carrier according to the first aspect of the invention, i.e. each hole in its contact surface may preferably comprise two oppositely slanted opposing facets that include an angle of less than about (n₂/n₁)·140°, with n₁ and n₂ being the refractive indices of the carrier and the sample, respectively.

The input light beam may in general traverse any number of carrier holes larger than one before leaving the carrier as the output light beam. Most preferably, it traverses through a number of two to six holes. Limiting the number of passages to these figures has proved to provide an optimal ratio between the intensity of the input light beam and the intensity of the resulting output light beam.

The input light beam emitted by the light source propagates through the carrier until it impinges on a first facet of a (first) hole. Preferably, this incidence takes place at approximately the Brewster angle. As known to a person skilled in the art, the Brewster angle is an angle of incidence at which only those components of unpolarized light are reflected that are polarized parallel to the reflecting interface. In terms of the refraction indices n₁ of the medium through which the light beam approaches the interface and n₂ of the medium at the opposite side of the interface, the Brewster angle has the value arctan(n₂/n₁). In the apparatus according to the present invention, and incidence at approximately the Brewster angle has the advantage that losses due to reflection are minimized.

The input light beam that is generated by the light source may optionally consist of polarized light, in particular linearly polarized light. Selecting a suitable polarization of the input light can help to minimize light losses during the refractions taking place when the input light beam traverses several holes.

According to another preferred embodiment of the apparatus, the input light beam reaches the contact surface of the carrier at an angle of incidence of about 65° to about 75° (said angle being defined with respect to the normal of the contact surface). In this case the geometry is similar to that of designs in which (frustrated) total internal reflection (FTIR) takes place at the contact surface of the carrier (cf. WO 2009/083814 A2, WO 2009/098623 A1, or WO 2009/083814 A2). This allows to use the readout equipment (light source, light detector etc.) of these apparatuses for the processing of a carrier according to the present invention.

In the following, preferred embodiments of the invention will be described that relate both to the carrier and the apparatus according to the first and second aspect of the invention.

In one such preferred embodiment, the holes in the contact surface of the carrier have the form of grooves extending parallel to each other. In this way a design is achieved in which optical conditions are invariant in the extension direction of the grooves.

The oppositely slanted, opposing facets of the holes in the contact surface of the carrier may typically include an angle of less than about 120°, preferably less than about 110°. Particularly preferred angles between the facets are about 100° and about 86°. It turns out that these values are well compatible to the geometry of known (FTIR) apparatuses probing fluids with a refractive index close to the refractive index of water.

In general, the holes in the contact surface of the carrier may have an arbitrary cross section, for example an asymmetric cross section (with respect to the normal of the contact surface), which typically results in an asymmetry between input light beam and output light beam. In another preferred embodiment, the holes have a symmetric cross section with respect to the normal of the contact surface. This allows to implement a symmetric geometry of input and output light beam. Moreover, such a symmetric cross section guarantees that the carrier can be used in two orientations rotated 180° about the normal of the contact surface.

A particularly preferred shape of the holes is such that they have a triangular cross section, two sides of this cross section defining the slanted opposing facets.

The depth of the holes (measured from their tip to their bottom) is preferably less than about 15 μm, most preferably less than about 10 μm. The depth of the holes determines the thickness of the volume that is reached by the input light beam. When for example the attachment of typical magnetic label particles to the contact surface shall be tested, the mentioned values of the depth are favorable as they restrict the interaction to a thin fluid layer containing the particles bound to the contact surface. In general terms, the depth of the holes should be proportional to the thickness of particles that shall be detected at the contact surface. If the objective of the measurement is a more general extinction or absorption measurement, deeper holes could be used to increase the length of the light path in the fluid.

The contact surface of the carrier may optionally comprise a plurality of isolated investigation regions that have the described optical structure of holes. Manipulations of a sample can then take place simultaneously in several distinct investigation regions.

According to a further development of the invention, the holes are coated with binding sites for target components of the sample. Such binding sites may for example be biological molecules that specifically bind to particular molecules in a sample.

In a preferred embodiment of the invention, the apparatus comprises a magnetic field generator for generating a magnetic field in the sample chamber. Via such magnetic field it is possible to exert forces on magnetic particles (e.g. beads) and to move them in a desired way.

The apparatus may optionally further comprise a light detector for detecting a characteristic parameter of light originating from the input light beam, particularly a characteristic parameter of the output light beam. The light detector may comprise any suitable sensor or plurality of sensors by which light of a given spectrum can be detected, for example a 1D or 2D detector array, single-spot or multiple-spot photodiodes, photo resistors, photocells, a CCD or CMOS chip, or a photo multiplier tube. The detected characteristic parameter may particularly be the intensity or an image of the intensity profile of the output light beam.

The optical structure on the carrier may have spatially homogenous optical properties, e.g. realized by a regular, periodic pattern of identical holes. It may however also have locally varying optical properties, for example by a varying shape (inclination, depth, pitch etc.) of the holes that constitute the structure.

According to a further development of the embodiment with a light detector, the apparatus further comprises an evaluation unit for evaluating the detection signal provided by the light detector with respect to the presence and/or amount of a target component in the sample chamber. An increasing concentration of particles in a sample may for example lead to more scattering and/or absorption of input light after its refraction into the sample chamber and thus to a decreasing intensity of the output light beam. An increasing concentration of a photoluminescent substance, on the contrary, will lead to an increasing amount of photoluminescence light. In any case, the detected light will carry information about the presence and amount of a target component one is interested in.

The invention further relates to the use of the carrier and the apparatus described above for molecular diagnostics, biological sample analysis, or chemical sample analysis, food analysis, and/or forensic analysis. Molecular diagnostics may for example be accomplished with the help of magnetic beads or photoluminescent particles that are directly or indirectly attached to target components.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 shows schematically an apparatus and a carrier according to the present invention;

FIG. 2 shows an enlarged view of the prismatic structure of the carrier of FIG. 1;

FIG. 3 illustrates in a sectional view through a carrier with a prismatic structure ray tracing results for a narrow input light beam that successively traverses six grooves at the contact surface;

FIG. 4 illustrates ray tracing results for a carrier with a prismatic structure having a top angle of 100° and for an input light beam of 1° divergence;

FIG. 5 illustrates ray tracing results for a carrier with a prismatic structure having a top angle of 86° and for an input light beam of 1° divergence;

FIG. 6 illustrates ray tracing results for the carrier of FIG. 5 for an input light beam of 5° divergence;

FIG. 7 shows the reflectivity of light components with polarization parallel and vertical to an interface, respectively, in dependence on the angle of incidence on the substrate-fluid interface.

Like reference numbers or numbers differing by integer multiples of 100 refer in the Figures to identical or similar components. It should be noted that the Figures are not to scale; in particular, the aspect ratio in FIGS. 2-6 is not to scale.

### DESCRIPTION OF PREFERRED EMBODIMENTS

The invention will in the following be described with respect to biosensors for the detection of specific components in body fluids like saliva, urine, blood. These biosensors may preferably make use of magnetic beads covered with antibodies and of specific magnetic actuation protocols to optimize the assay performance. The presence of target molecules in a sample can then be detected by the binding or prohibited binding of magnetic beads to detection spot areas on a contact surface of a carrier or cartridge covered with specific antibodies. The presence of beads bound to the surface shall be detected by optical means, and the design of the corresponding disposable cartridge shall be kept as simple as possible.

One known read out method in biosensors applies frustrated total internal reflection (FTIR, cf. WO 2009/083814 A2). For this FTIR detection, the illumination beam approaches the area of interest under an angle larger than the critical angle for total internal reflection. The reflected light is imaged on a detector (CCD camera or CMOS detector). The evanescent field at the position of the detection spots in the biosensor can interact with the magnetic beads close to the surface, thereby reducing the intensity of the reflected beam. In this way the spots where beads are bound on the cartridge surface become visible as dark spots in the image. A disadvantage of FTIR detection is that the evanescent field has a penetration depth that is considerably smaller than the size of the typically used magnetic beads. This reduces the sensitivity of the detection method.

Another known read out method applies “double refractive detection” (DRD, cf. WO 2009/125339 A2). For this DRD detection, the detection beam is refracted by a prismatic interface structure between a transparent substrate and a fluid in contact with the substrate in such a way that the detection beam enters the fluid by refraction at one of the prismatic interfaces and leaves the fluid by refraction at the next interface. In this way only a narrow sheet of fluid in the direct vicinity of the refracting structure is probed for extinction. This makes the method particularly suited for the optical detection of labels like magnetic beads that are specifically bound to the interface area by means of, for instance, a sandwich assay. Unbound optical labels in the bulk liquid above the interface need to be excluded from the detection. This sensor can be denoted as “double refractive detection” since the excitation light beam is refracted twice at the optical interface: refracting in and out of the liquid sample above the optical interface.

A problem with DRD is that it is difficult with practical refractive indices of substrates and sample fluids to realize a total beam deflection of 40° between incoming and outgoing beam which is a typical standard for the FTIR detection systems. So, in order to realize compatibility with FTIR systems, the internal angle of incidence on the prismatic DRD surfaces has to be chosen close to the critical angle for total internal reflection. This results in high reflection losses. Moreover, the system becomes very sensitive to small variations in angle of incidence and variations in the refractive index of the fluids to be analyzed. This angle sensitivity also makes it more difficult to use divergent light for the illumination and imaging on the camera of the detection area. Using a low divergence (low numerical aperture for the imaging) reduces the image quality and makes the system sensitive to all optical imperfections in the cartridge and imaging optics.

For these reasons, the present invention aims at a reduction of the reflection losses compared to DRD and an increase of tolerances with respect to angles, refractive indices, and/or beam divergence. To achieve these goals, it is proposed to use multiple-refraction instead of double-refraction. Thus the total beam deflection from the incoming direction to the direction of detection is subdivided over more than two refractions. This has the advantage that the beam deflection for each individual refraction can be reduced. This is much easier to realize with the limited effective refractive index available (with the index n₁ of refraction of cartridge substrate material typically being about 1.5-1.6, and n₂ of water/plasma being about 1.33-1.35, the effective refractive index Neff=n₁/n₂ is about 1.14). If, for instance, quadruple refraction is used, the angle of incidence at the substrate-fluid interfaces can be chosen much closer to the Brewster angle. This reduces the reflection losses considerably and makes the reflection losses less angle sensitive. Another consequence of this approach is that several light rays pass the same fluid volume under different angles, increasing the extinction effect for an individual particle (label) to be detected. The length of the light path through the fluid is increased. This approach is especially effective for the measurement of extinction close to a surface, for instance to detect absorption or scattering of particles bound to the surface. The fact that the effective surface area is increased as well can be an additional advantage for the sensitive detection of a low concentration of labels.

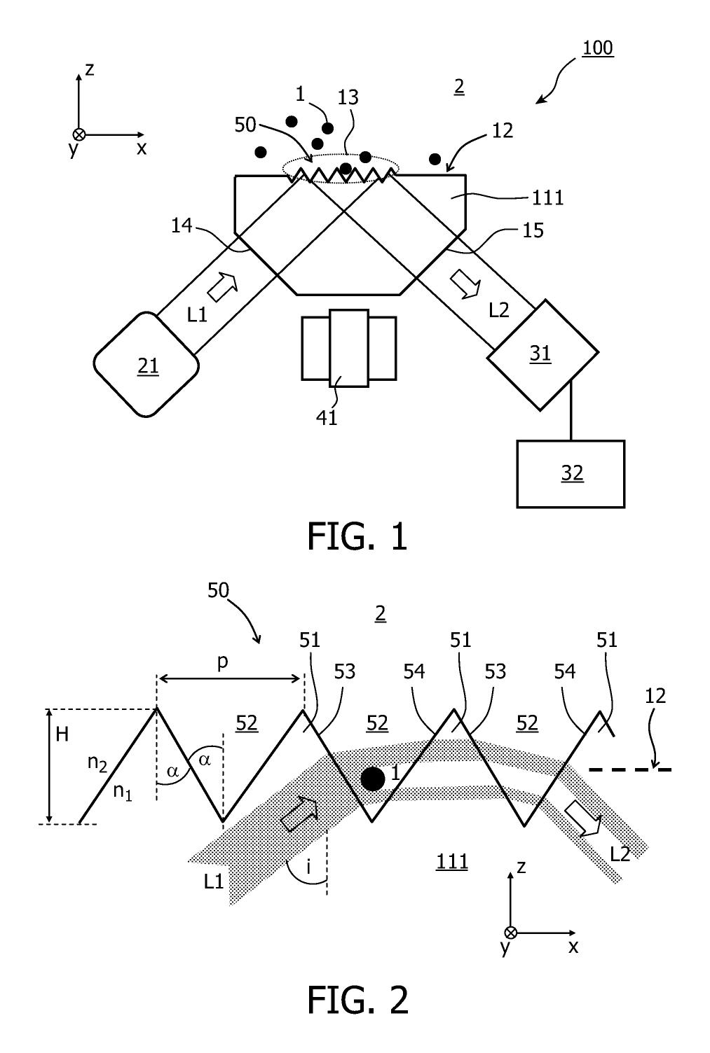

FIG. 1 shows an exemplary realization of the above approach with an apparatus 100 according to the present invention. A central component of this apparatus is the cartridge/carrier 111 that may for example be made from a substrate like glass or transparent plastic like polystyrene. The carrier 111 is located next to a sample chamber 2 in which a sample fluid with target components to be detected (e.g. drugs, antibodies, DNA, etc.) can be provided. The sample further comprises magnetic particles, for example super-paramagnetic beads, wherein these particles are usually bound as labels to the aforementioned target components. For simplicity only the combination of target components and magnetic particles is shown in the Figure and will be called “target particle” 1 in the following. It should be noted that instead of magnetic particles other label particles, for example electrically charged or photoluminescent particles, could be used as well.

The interface between the carrier 111 and the sample chamber 2 is formed by a surface called “contact surface” 12. This contact surface 12 is optionally coated with capture elements (not shown), e.g. antibodies or proteins, which can specifically bind the target particles. Moreover, the contact surface comprises in an “investigation region” 13 an optical structure 50 that will be explained below. It should be noted that the contact surface will below geometrically be considered as being planar, thus ignoring (or averaging out) the local optical structure 50.

For the manipulation of magnetic target particles the apparatus 100 may be comprised with a magnetic field generator 41, for example an electromagnet with a coil and a core, for controllably generating a magnetic field at the contact surface 12 and in the adjacent space of the sample chamber 2. With the help of this magnetic field, the target particles 1 can be manipulated, i.e. be magnetized and particularly be moved (if magnetic fields with gradients are used). Thus it is for example possible to attract target particles 1 to the contact surface 12 in order to accelerate their binding to said surface, or to wash unbound target particles away from the contact surface before a measurement. While the Figure shows a single magnetic coil below the carrier, it should be noted that one or more magnetic coils can be disposed at other locations, too.

The apparatus 100 further comprises a light source 21 that generates an input light beam L1 which is transmitted into the carrier 111 through an “entrance window” 14. As light source 21, a laser or an LED, particularly a commercial DVD (λ=658 nm) laser-diode can be used. A collimator lens may be used to make the input light beam L1 parallel, and a pinhole of e.g. 1 mm diameter may be used to reduce the beam diameter. In general, preferably, the used light beam should be (quasi) monochromatic and (quasi) collimated.

The input light beam L1 impinges onto an investigation region 13 at the contact surface 12 of the carrier 111, where it is refracted into the sample chamber 2 by the optical structure 50. Light of the input light beam that is re-collected from the sample chamber by the optical structure 50 constitutes an output light beam L2.

The output light beam L2 propagates through the carrier 111, leaves it through another surface (“exit window” 15), and is detected by a light detector 31. The light detector 31 determines the amount of light of the output light beam L2 (e.g. expressed by the light intensity of this light beam in the whole spectrum or a certain part of the spectrum). The measured sensor signals are evaluated and optionally monitored over an observation period by an evaluation and recording module 32 that is coupled to the detector 31. An additional lens may be used between exit window 15 and detector 31 for imaging the investigation region 13 onto the detector 31, that optionally can be a 2-dimensional CCD or CMOS detector.

It should be noted that the carrier does not necessarily need to have a slanted entrance window 14 and/or exit window 15, as these facets may for example be part of the external (reader) optics. A matching fluid may for example be used to couple in light from an external reader into the disposable cartridge.

It is possible to use the light detector 31 also for the sampling of photoluminescence light emitted by photoluminescent particles 1 which were stimulated by the input light beam L1, wherein this photoluminescence may for example spectrally be discriminated from other light, e.g. light of the input light beam that was not scattered in the sample chamber. Though the following description concentrates on the measurement of non-scattered light, the principles discussed here can mutatis mutandis be applied to the detection of photoluminescence, too. Note that in the case of photoluminescence or direct scattering detection the detector 31 may also be positioned in a direction other than the output light beam L2, e.g. in a direction perpendicular to the substrate interface 12.

An exemplary design of the optical structure 50 on the surface of the transparent carrier 111 is shown in more detail in FIG. 2. This optical structure consists of grooves 52 and wedges 51 with a triangular cross section which extend in y-direction, i.e. perpendicular to the drawing plane. The wedges 51 are repeated in a regular pattern in x-direction and encompass between them the triangular grooves 52. The tip angle of the wedges 51 as well as the bottom angle of the grooves 52 will be denoted as 2α, and it is preferably smaller than about (n₂/n₁)·140°≈(1.14)⁻¹·140°≈120° (i.e. α≦60°).

When the input light beam L1 (or, more precisely, a sub-beam of the whole input light beam L1) impinges from the carrier side onto a first “excitation facet” 53 of a first wedge 51, it will be refracted into the adjacent first groove 52 of the sample chamber 2. Within the first groove 52, the light propagates until it impinges onto an oppositely slanted first “collection facet” 54 of the neighboring second wedge. Here the input light that was not absorbed, scattered, or otherwise lost on its way through the sample chamber 2 enters the second wedge 51. It propagates through the second wedge until it reaches the (second) “excitation facet” 53 thereof, where the light is refracted into the adjacent second groove 52. In the shown illustration, the light is collected by a second collection facet 54 of said second groove and directed away from the contact surface 12 as the output light beam L2. Obviously the amount of light in the output light beam L2 is inversely correlated to the concentration of target particles 1 in the grooves 52 of the sample chamber.

As a result of the described process, a thin sheet of light is propagating along the contact surface, wherein the thickness of this sheet is determined by the groove geometry (angle 2α, depth H) and the pitch p (distance in x-direction) of the wedges 51. A further advantage of the design is that illumination and detection can both be performed at the non-fluidics side of the carrier.

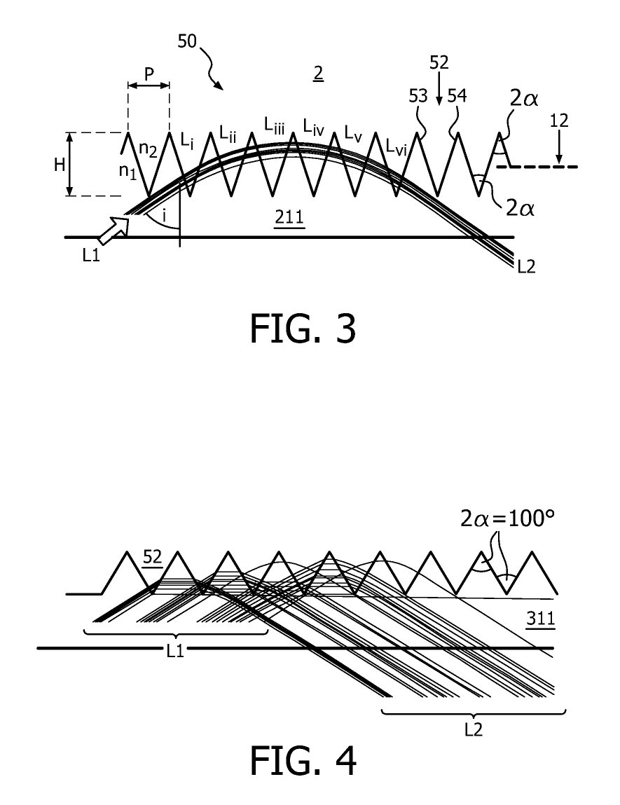

FIG. 3 illustrates the basic concept of multiple-refraction-detection using a ray tracing result for a prismatic optical structure 50 with a relatively sharp groove angle 2α. The beam deflection between the input light beam L1 and the output light beam L2 is divided over a number of six individual passages of grooves 52. Thus the incoming input light beam L1 encounters more than two refraction events before it is entering the cartridge 211 again (becoming the output light beam L2). The number of groove-passages N_{R} (enumerated i to vi in the drawing) before the beam is finally refracted back into the cartridge 211 depends on the refractive indices of cartridge (n₁) and sample (n₂) materials, on the entrance angle i of the input light beam L1, and on the top-angle 2α of the triangular structures in the cartridge.

The advantage of the shown geometry is that it allows a kind of multiple-pass absorption-scattering detection of analytes in the fluid, which increases the absorption and/or scattering signal contained in output light beam L2. As a result the method gives a stronger signal, and hence a better signal-to-noise ratio. The height H of the volume that is probed by this method is determined by the pitch p and the top angle 2α of the prismatic structure.

In the following, the practical application of the present invention is illustrated by a number of examples for a plastic substrate material of the cartridge with a refractive index n₁ of 1.54 and a sample fluid with a refractive index n₂ of 1.35. It will be clear that optimal angles for the prismatic structures depend on the actual refractive indices; the basic concept remains the same.

FIG. 4 shows a typical ray tracing result for a prismatic structure with a top/groove angle 2α of 100°. The refractive index ratio n₁/n₂ between the cartridge material and the fluid is 1.14 (=1.54/1.35). The angle i of incidence of the incoming input light beam L1 is 73.5° with the normal of the contact surface, and the divergence of the input light beam is 1° (FWHM).

In this embodiment of a 4-refraction-detection or quadruple refraction detection, the total deflection of the input light beam L1 towards the detector is subdivided over four successive refractions. This is realized for the refractive indices used in the present examples by use of a prismatic structure with the mentioned top angle 2α of 100°.

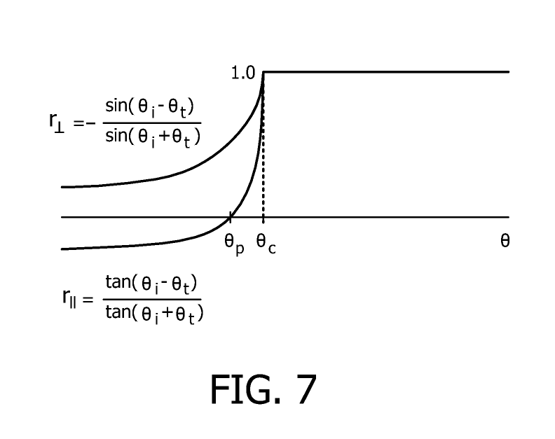

At low divergence of the incoming beam, 1° in this example, the intensity loss due to reflection is only 5% and 15% for the principal polarization directions. This is considerably lower than in the case of DRD (10% and 22%) in spite of the fact that the light rays encounter four interfaces in this configuration instead of two for DRD. This is due to the fact that the refraction takes place at lower angles of incidence at the substrate-fluid interfaces than in the analogous case for DRD. In said analogous case of DRD (with same parameters as 4-refraction-detection but a top angle of 144°), the refraction takes place at internal angles of 56.5° for the materials used in this example. This angle is situated between Brewster angle (41°) and the critical angle of total internal reflection (61°). In this region the reflection losses are high and strongly angle-dependent. This can be seen from FIG. 7, which shows the reflectivity coefficients r_{⊥} and r_{∥} for the polarization components perpendicular and parallel to the interface, respectively, in dependence on the angle θ of incidence. It can be seen that one of the principal polarization directions has zero reflectance at Brewster angle θₚ and light is fully reflected for both polarizations above the critical angle θ_{c}, for total internal reflection. The situation for the 4-refraction-detection configuration of FIG. 4 is more favorable because the internal angles of incidence are further away from the critical angle θ_{c} and closer to Brewster angle θₚ, resulting in lower reflection losses. So, even in spite of the four refractions instead of two, the reflection losses are lower.

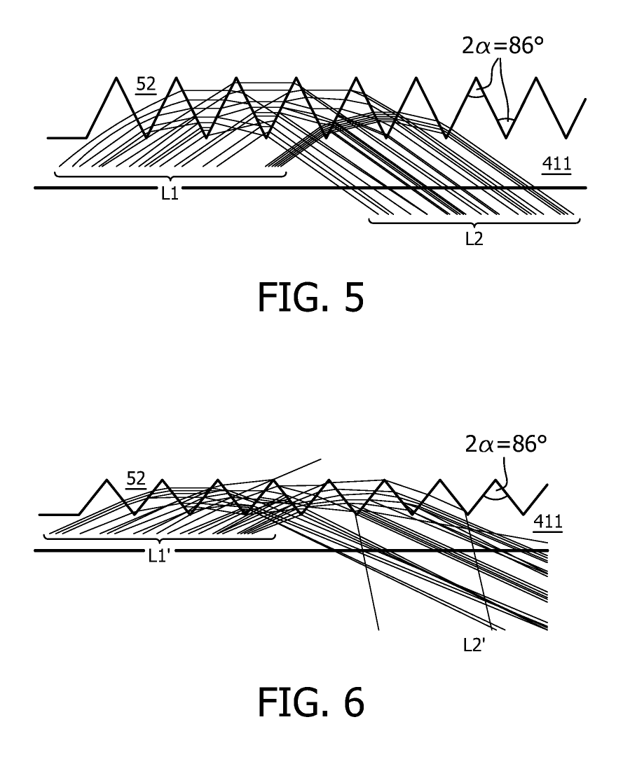

FIG. 5 shows a typical ray tracing result for a prismatic structure with a top/groove angle 2α of 86°. The refractive index ratio between the cartridge material and the fluid is again 1.14 (1.54/1.35), the angle of incidence of the incoming input light beam L1 is 70° with the normal of the contact surface, and the divergence is 1° (FWHM). In this embodiment of a “6-refraction-detection”, the total deflection of the incoming beam towards the detector is subdivided over six successive refractions. This is realized by the use of a prismatic structure with a top/groove angle 2α of 86°.

The reflection losses in this case are comparable with the 4-refraction-detection situation, in spite of the fact that six interfaces are passed by the light rays on their passage through the detection area. The attractiveness of this embodiment is that the angle of incidence on the overall cartridge-fluid interface (contact surface) is 70°, which is exactly the same as the typically chosen FTIR angle of incidence. So, this embodiment is backwards compatible with FTIR analyzers.

FIG. 6 shows a typical ray tracing result for the same prismatic structure with a top/groove angle 2α of 86°, a refractive index ratio of 1.14, and an angle of incidence of 70°. In contrast to FIG. 5, the divergence of the input light beam is now 5° (FWHM). The Figure illustrates that the approach not only works for incoming beams with a very low divergence. The reflection losses are somewhat higher than for 1° divergence because some rays are reflected in the wrong direction. But the calculated efficiency (about 75% and 84% for the parallel and perpendicular polarization directions) is still significantly better than for DRD at the same divergence (68% and 79%).

In case the described concepts are used to measure the concentration of labels specifically bound to a contact surface, it may have advantages to limit the height H of the prismatic structure to 1-10 μm by choosing a relatively small pitch p of the prismatic structure. This reduces the dimension of the area from which the unbound labels must be removed by the (magnetic) washing step.

If the concepts are used to measure absorption of fluids in clinical chemistry applications, it may be better to use more macroscopic prismatic structures that are more robust and have a longer light path through the fluid.

In case polarized light can be used for the input light beam, the reflection loss can be reduced to almost zero by choosing the angle of incidence close to Brewster angle.

The embodiments described above are symmetric in the sense that the angle of incidence of the input light beam and the output light beam are almost identical. In addition the prismatic structures used in the examples are symmetric. This does not exclude the possibility, however, to use the concept in an asymmetric configuration, in which the prismatic structure may be asymmetric and/or the angles of the incoming and outgoing light beams may be different.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. (canceled)

2. An apparatus for optical manipulations of a sample in a sample chamber, comprising:
a) a carrier having a contact surface with a plurality of holes;
b) a light source for emitting an input light beam through the carrier towards its contact; wherein, for a given sample with a refractive index between about 1.2 and about 1.5 filling the holes, the arrangement of said components is such that at least a part of the input light beam traverses at least two holes before leaving the carrier as an output light beam.

3. The apparatus according to claim 2,
characterized in that each hole comprises two oppositely slanted opposing facets that include an angle (2α) of less than about (n₂/n₁)·140°, wherein n₁ is the refractive index of the carrier and n₂ ranges between about 1.2 and about 1.5, preferably between about 1.33 and 1.35.

4. The apparatus according to claim 2,
characterized in that said part of the input light beam traverses through four to six holes.

5. The apparatus according to claim 2,
characterized in that the input light beam impinges onto the first facet approximately at the Brewster angle (θₚ).

6. The apparatus according to claim 2,
characterized in that the input light beam comprises polarized light.

7. The apparatus according to claim 2,
characterized in that the input light beam reaches the contact surface at an angle of incidence of about 65° to 75°, said angle being defined with respect to the normal of the contact surface.

8. The apparatus according to claim 2,
characterized in that the refractive index n₁ of the carrier ranges between about 1.4 and 1.8, preferably between about 1.5 and 1.6.

9. (canceled)

10. The apparatus according to claim 3,
characterized in that the facets include an angle (2α) of less than about 120°, preferably less than about 110°, most preferably of about 100° or about 86°.

11. The apparatus according to claim 2,
characterized in that the holes have the form of grooves extending parallel to each other.

12. The apparatus according to claim 2,
characterized in that the holes have a symmetric cross section.

13. The apparatus according to claim 2,
characterized in that the holes have a triangular cross section.

14. The apparatus according to claim 2,
characterized in that the holes have a depth (H) of less than about 15 μm, preferably less than about 10 μm.

15. Use of the apparatus according to claim 2 for molecular diagnostics, biological sample analysis, chemical sample analysis, food analysis, and/or forensic analysis.
